(19) United States
(12) Patent Application Publication
(10) Pub. No.: US 2005/0102707 A1
(43) Pub. Date: May 12, 2005

(54) Digital interactive phrasing system and method

(76) Inventor: Myles Schnitman, Bellerose, NY (US)

Correspondence Address: LAW OFFICES OF CLEMENT CHENG, 17220 NEWHOPE STREET #127, FOUNTAIN VALLEY, CA, 92708, US

(21) Appl. No.: 10/704,314

(22) Filed: Nov. 7, 2003

(51) Int. Cl. H04N 7/173; G06F 17/24; G06F 17/00; G06F 15/00; H04N 7/16

(52) U.S. Cl. 725/135; 725/115; 715/500.1; 715/501.1; 715/512

(57) ABSTRACT

A digital interactive phrasing system and method allows a user to select and control playback of audio or visual from various types of digital media. The DIP format enables the user to edit digitally prepared elements such as audio or video to create a custom mix. Original source material contained on an optical disk provides pre edited digitally prepared elements for user arrangement into coded sequences. The coded sequence data is saved in memory for future reassembly from original source material.

### BACKGROUND

Contemporary music listeners have grown accustomed to increasing control over the selection and sequencing of recorded music tracks. Advances in music engineering have led to the popularity of music duets where singers sing together, where either both singers are recorded together or have their individual recordings digitally remixed together. The sustained popularity of cover songs, which involves one musical artist performing a signature song of another artist; remains a mainstay of both live performance and recorded music. A similar editing of media elements can be found in the use of trailers or promotional clips in the marketing of TV shows and feature films. The appeal of movie trailers is so significant that they are included in feature film DVD. Music videos make extensive use of mixing audio and visual elements together for a heightened comedic or dramatic effect. Furthermore, documentary filmmaking integrates a mixing of both audio and visual elements in developing a narrative presentation.

Music listeners enjoy a greater degree of interactivity and prefer recreating favorite tracks by making custom albums. Some music listeners also attempt to mix songs. The manual selection of songs and the mixing together of phrases of songs is time-consuming but allows a user a greater degree of interactive experience. The challenge of being a DJ encourages an individual to interact with the music and to create derivations of existing works of music and video in real time. Unfortunately, many people need extra help developing these song mixes. The record industry can benefit from greater user interaction with media.

With advances in technology, the music industry has faced increasing piracy and unauthorized copying of media. A secure format has yet to be successfully introduced to prevent piracy. As technological advances improve media storage, piracy becomes more widespread. A wide variety of prior art patents have attempted to deter unauthorized copying of media.

### OBJECTS OF THE INVENTION

To enable the ordinary music consumer to directly interact with commercially recorded music performed by one or more artists.

To encourage musical artists to contribute to new material as well as create new material in a new format.

To provide a new music recording format to which the recording industry can include antipiracy devices.

### BRIEF DESCRIPTION OF THE DRAWINGS

FIG. 1 is a diagram of digital interactive phrases showing different versions of the same song.

FIG. 2 is a diagram of digital interactive phrases allowing user insertion of unrelated phrases.

FIG. 3 is a diagram of digital interactive phrases allowing user insertion of television clips.

### DETAILED DESCRIPTION OF THE PREFERRED EMBODIMENT

A digital interactive phrasing system and method allows a user to select and control playback of audio or visual material from various types of digital media. The DIP format enables the user to edit digitally prepared elements such as audio or video to create a custom mix. The mix can be prepared in real-time similar to a DJ using vinyl records. The identification, presentation, selection, assembly, transcription and playback allow consumer selected sequences of digitally phrased elements such as songs, verses, dialogue, and video elements to be created.

Original source material contained on an optical disk provides pre-edited digitally prepared elements arranged in coded sequences. The coded sequence data is stored in memory for future reassembly from original source material.

Each media file main portion can be mixed with other media files in the DIP format. The tag locates the point at which the DIP phrase is spliced with other phrases. The splice can be a fade where the first DIP phrase is faded out while the second phase is faded in. The splice can also be shown as an instant transition. A variety of transition effects can be introduced and included in the commercial preparation and preediting of the DIP phrases. A variety of commercially available DSP digital signal processors can act as the central processing unit capable of receiving and processing DIP phrases and user inputs.

DIP phrases have a media file main portion with a tag at the beginning and end. The tag allows a digital central processing unit to identify the beginning and end of the media file main portion so that the central processing unit may digitally mix the elements together. The central processing unit accesses the media files from a database.

A simple application allows a user to mix the studio and live material of one artist. However, songs covered by other artists can be digitally woven together using the DIP format to create a hybrid of the two songs. Also, different songs can be digitally interwoven to create a hybrid or medley of different songs by the same or different artists. A musical phrase or verse is segmented into digital audio phrases or digital video phrases and assigned codes. The final mix can be heard through speakers and shown on a video screen such as a CRT Monitor or television.

For example, “Yesterday” by Paul McCartney
Version A may be marked as follows:
Yesterday A1
All my troubles seem so far away A2
Now looks as though they are here to stay A3
Oh I believe A4
In yesterday A5
   Version B may be marked as follows:
Yesterday B1
All my troubles seem so far away B2
Now looks as though they are here to stay B3
Oh I believe B4
In yesterday B5

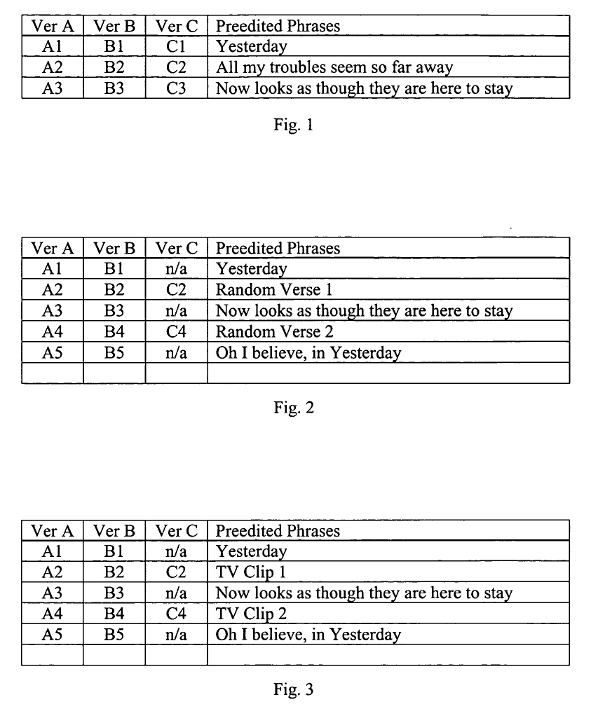

FIG. 1, The coded elements can be keyed coded into a visual screen display such as an LCD display which once confirmed by the consumer would assemble and play the coupled phrases in a sequence coded by the listener, such as A1 B2 B3 A4 B5. The user may input coding by pressing a button indicating the version of the next phrase that the user has selected. A user selects the version before play. In any case, the user coding also called user selection allows a custom mixing without requiring manual user selection of the point at which the phrases begin and end.

The different phrased versions of different media are pre-edited so that they appropriately mix with other phrases. The pre-edited phrases have tags at the beginning and end to define the digital interactive phrase. A standard coding of digital interactive phrases will be used.

However users may input additional code of their own derivation. A user may also share coding with other users. Codes could be exchanged freely over the Internet since the actual files are not being exchanged. Song codings could also be sold.

Recordings can be made in different styles. Each version can be sung with differing vocal techniques such as offering a clean sound, a raspy sound, a staccato sound, a well enunciated sound, or a quiet whispering sound. A memory database stores codings. Each song would have its own index code as well. For example, the song Yesterday may be represented as YE73629. Each coded permutation would be available for print out enabling consumers to share codes but not music files.

The DIP coded songs may be stored on an optical storage disk. Each disk can contain a variety of versions that act as library of material a listener may use to assemble a custom mix. The mixes can be copy protected to be played and created only if the CPU accesses the optical disks. Encoding DIP software includes the steps of identification, cutting, selection, assembly, and playing. The DIP format may be stored on a memory device that sequences and mixes the file. The DIP system may use an entire song as a digital phrase. The digital phrase may also be as short as a measure or a stanza.

A song may have a choice of only two versions in certain pre-edited phrases FIG. 2, A1, B1. A user may select between either version. The song may also include a random verse insert that is not traditionally included as a part of the song, such as variant lyrics or a phrase from a different song. The random phrase or verse would be composed or approved by the author for artistic compatibility with the main song. Analogous embodiments include the addition of video that accompanies the selected music.

FIG. 3, The song may also include a random verse insert that is not traditionally included as a part of the song, and not a variant lyric or phrase from a different song, but rather a prerecorded multimedia DIP such as a TV clip. A TV clip could be approved by the author for artistic compatibility with the main song A1, A3, A5. The DIP system and method may motivate contemporary artists to perform old songs. A user may then mix digital interactive phrases from the contemporary artist with original performers of old songs.

In FIG. 3, the TV clip A2 the royalties and licenses for copyrights would be arranged contractually between the various copyright owners when producing in the DIP format. FIG. 3, A2 could be a recording of a contemporary performer singing the same song. FIG. 3, B2 could be a recording of the original performers singing the same song. FIG. 3, C3 could be a recording of a different song having the same subject matter as the original song, and having a similar musical rhythm, tempo, and melody.

A user can copy from TV and make DIP clips, and make royalty payment arrangements when required. It should be emphasized that the preedited DIP phrases have unique codes assigned. This standardization allows for the free exchange of codes over the Internet, etc. The actual content of the DIP phrases can be copy protected by a commonly available and standard anti-piracy protocol. Consumers may create their own DIP phrases using commercially prepared tags and splices.

The foregoing describes the preferred embodiments of the invention and modifications may be made without departing from the spirit and scope of the invention as set forth in the following claims.

1. A method of creating mixed digital media comprising the steps of:
a. defining a plurality of digital interactive phrases in source material, each digital interactive phrase having a preedited media file defined by a predefined tag identifier;
b. providing a database storing said plurality of digital interactive phrases;
c. providing a central processing unit;
d. accessing the database storing said plurality of digital interactive phrases via the central processing unit, wherein the central processing unit finds digital interactive phrases by the tag identifier portion;
e. configuring the central processing unit to receive inputs from a user, wherein the inputs include: a sequence selection input for receiving digital interactive phrase coding, and index code input for receiving index codes, wherein the preedited media files can be assembled by a user and spliced together at their predefined tag identifiers;
f. saving compiled coded sequence data for future reassembly of source material.

2. The method of claim 1 wherein the step of defining a plurality of digital interactive phrases includes preedited media files in the form of songs.

3. The method of claim 1 wherein the step of defining a plurality of digital interactive phrases includes preedited media files in the form of dialogue.

4. The method of claim 1 wherein the step of defining a plurality of digital interactive phrases includes preedited media files in the form of music video.

5. The method of claim 1 further comprising the step of: providing copy protection to prevent sharing of the content of DIP files while allowing sharing of coding between consumers.

6. A method of mixing digital media comprising the steps of:
a. defining digital interactive phrases, each digital interactive phrase comprising a preedited media file defined by a begining tag identifier and an ending tag identifier;
b. providing a read only optical disk database storing said plurality of digital interactive phrases;
c. providing a central processing unit;
d. accessing the database storing said plurality of digital interactive phrases via the central processing unit, wherein the central processing unit finds digital interactive phrases by the tag identifier portion;
e. configuring the central processing unit to receive inputs from a user, wherein the inputs include: a sequence selection input for receiving digital interactive phrase coding, and an index code input for receiving index codes wherein the preedited media files can be assembled by a user and spliced together at their predefined tag identifiers;
f. displaying the compiled digital mix on an audio output and a visual output.

7. The method of claim 6 wherein the step of defining a plurality of digital interactive phrases includes preedited media files in the form of songs.

8. The method of claim 6 wherein the step of defining a plurality of digital interactive phrases includes preedited media files in the form of dialogue.

9. The method of claim 6 wherein the step of defining a plurality of digital interactive phrases includes preedited media files in the form of music video.

10. A method of mixing digital media comprising the steps of: preediting digital interactive phrases of varying length; configuring a CPU to receive played digital interactive phrases from two or more different commercially prepared optical disks; configuring a CPU to intermix preedited digital interactive phrases of varying length; receiving a user input of unique preassigned DIP index codes; then digitally storing the resulting mix for replay;
storing coding for exchange with other users.

11. The method of claim 10 further comprising the step of: providing copy protection to prevent sharing of the content of DIP files while allowing sharing of coding between consumers.
